(19) United States
(12) Patent Application Publication
(10) Pub. No.: US 2007/0180268 A1
(43) Pub. Date: Aug. 2, 2007

(54) Method for creating an encrypted back-up file and method for restoring data from a back-up file in a pocket PC

(76) Inventors: Diana Filimon, Gersthofen (DE); Stephan Muller, Augsburg (DE)

Correspondence Address: EDELL, SHAPIRO & FINNAN, LLC, 1901 RESEARCH BLVD., SUITE 400, ROCKVILLE, MD, 20850, US

(21) Appl. No.: 11/490,494

(22) Filed: Jul. 21, 2006

(30) Foreign Application Priority Data
Jul. 22, 2005 (EP) EP05016015.9

(51) Int. Cl. G06F 12/14

(52) U.S. Cl. 713/192

(57) ABSTRACT

A password that is stored in the BIOS and/or operating system of the pocket PC is used to encrypt/decrypt the back-up file. By using the password, which is already present, for example in connection with access protection, the requirement of the user entering a key can be eliminated without having to dispense with the advantages of an encrypted back-up file.

### CROSS REFERENCE TO RELATED APPLICATIONS

This application claims priority under 35 USC §119 to European Application No. 05016015.9, filed on Jul. 22, 2005, and titled “Method for Creating an Encrypted Back-up File and Method for Restoring Data From this Back-up File in a Pocket PC,” the entire contents of which are hereby incorporated by reference.

### FIELD OF THE INVENTION

The invention relates to a method for creating an encrypted back-up file in a pocket PC and to a method for restoring data from an encrypted back-up file in a pocket PC. The invention also relates to a pocket PC which is suitable for carrying out the methods.

### BACKGROUND

Portable computers which can be easily held in one hand are referred to as pocket PCs. Alternatively, the terms handhelds or organizers are also customary. Mobile telephones, which have functions that go beyond making telephone calls and sending short messages and which are frequently referred to as smart phones, likewise belong to this group. They have the feature in common that they are considerably smaller than other portable computers, for example laptops or notebooks. Application programs from the areas of address and appointment management, text processing or data presentation are frequently also available for pocket PCs in versions having slightly reduced capability.

Pocket PCs usually have a volatile memory area and a non-volatile storage medium. In contrast to desktop computers or relatively large portable computers (notebooks, laptops), pocket PCs are not completely switched off, in order to be shut down, but rather are merely put into a stand-by mode during normal use in daily operation. In this stand-by mode, the volatile memory which, on the one hand, functions as the main memory and, on the other hand, usually contains all of the user data, remains powered and its contents are thus retained. This method of operation is advantageous for the user since, from the stand-by mode, the pocket PC is ready for operation again in a considerably smaller amount of time than if data had to be loaded into the volatile memory from the non-volatile storage medium. As a result of the use of volatile memories having low power consumption, for example those using CMOS technology, this method of operation can also be combined with a sufficient battery life.

In addition to the stand-by mode, it is also possible to switch off the pocket PC completely, including the volatile memory. This is appropriate, for example, when the pocket PC is not used for a relatively long period of time. Provision is also typically made for the pocket PC to automatically assume this state when the battery state of charge becomes so critical that even stand-by operation cannot be maintained. If the pocket PC has been intentionally or unintentionally completely switched off in this manner, it is necessary to restart the system (frequently referred to as a cold start) in order to resume operation. In this case, the BIOS (Basic Input Output System) and the operating system of the pocket PC are restarted in succession, it being known that either the BIOS or the operating system or both provide(s) access protection for protecting against unauthorized use of the pocket PC. This is frequently effected in the form of a password check.

In order to protect against the loss of data, pocket PCs usually provide the opportunity to combine relevant contents of the volatile memory in a back-up file and to store this back-up file on the non-volatile storage medium, frequently a replaceable memory card using flash technology, of the pocket PC. After the pocket PC has been completely switched off and the BIOS and operating system have then been restarted as necessary, together with the entering of a password which is necessary under certain circumstances, the contents of the volatile memory can be restored from the back-up file. In order to protect the data contained in the back-up file, for example in the event of the pocket PC or the replaceable non-volatile storage medium being stolen or passed on, it is typically possible to encrypt the back-up file. For this purpose, when creating the back-up file, the user specifies a key, the correct input of which is a prerequisite for restoring the data in the back-up file.

It is found, in practice, that users rarely use this opportunity since the operation of entering a key is considered annoying. In addition, the risk of possible damage as a result of forgetting the key which has been entered seems to be rated higher than the risk of back-up files which have not been encrypted being able to be read in an unauthorized manner.

### SUMMARY

Therefore, the invention specifies methods for creating an encrypted back-up file in a pocket PC and for restoring the contents of the back-up file, in which the user is exonerated from the task of inputting a key but the data which has been backed up in the back-up file is nevertheless protected against unauthorized access. Also, the invention specifies a pocket PC which is suitable for carrying out the methods.

A password that is stored in the BIOS and/or operating system of the pocket PC is used to encrypt/decrypt the back-up file via the specified method. The invention thus makes use of the fact that a password is stored in the pocket PCs for particular purposes, e.g., for access protection which is implemented in the BIOS or in the operating system. According to the invention, this password or a part of it is used as a key for encrypting/decrypting the back-up file. The laborious task of inputting a key may thus be dispensed with without having to dispense with the advantages of an encrypted back-up file. This also makes it possible to automatically create the back-up file, e.g., at regular intervals, since it is not necessary to interact with the user.

The passwords in a pocket PC which are used in connection with access protection frequently have both device-dependent and device-independent parts, the latter of which can be altered by the user. It is advantageously possible to use either both parts to encrypt the back-up file, as a result of which the back-up file can be restored only on the device on which it was created, or only the device-independent part, as a result of which it is also possible to restore data from the back-up file on another device.

In one preferred embodiment of the method for restoring data, the user is requested to input a key if the password or, if present, the device-independent part of the password is not suitable for decrypting the back-up file. In that case, the key which has been input by the user is used to decrypt the back-up file.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The invention will be explained in more detail below with reference to an exemplary embodiment and with the aid of two figures, in which:

FIG. 1 shows the flowchart of an exemplary embodiment of the method for creating a back-up file in a pocket PC, and

FIG. 2 shows the flowchart of an exemplary embodiment of the method for decrypting an encrypted back-up file in a pocket PC.

### DETAILED DESCRIPTION

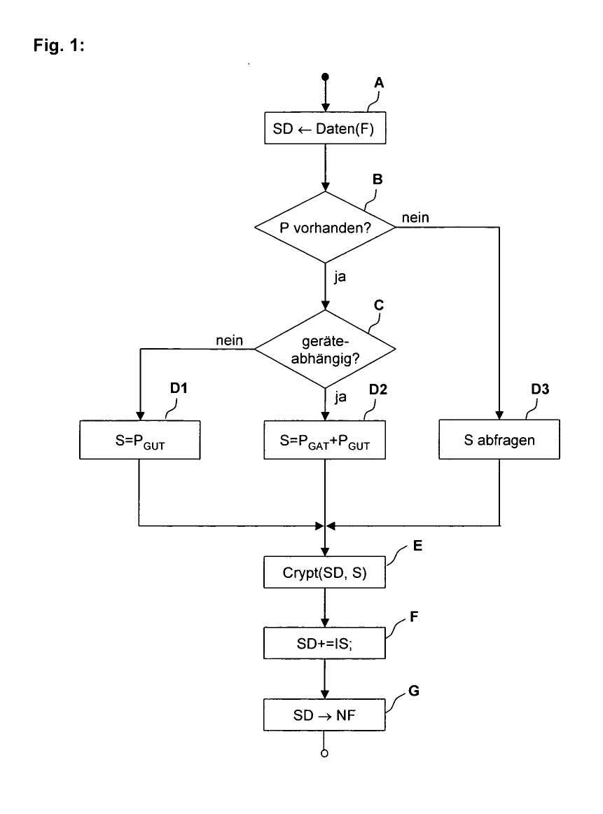

FIG. 1 is a flowchart illustrating a method for creating an encrypted back-up file for a pocket PC, beginning with an introductory operation A in which the relevant data (which is to be backed up) of a volatile memory F of a pocket PC is compiled in the form of a back-up file SD. Selection methods and criteria, according to which this may be effected, are known and are not explained any further here. In addition, the data format used for the back-up file SD and the fact of whether the data are possibly compressed after being compiled are not relevant to the inventive method.

Operation B of the method is depicted as a decision block, which determines whether a password P which could be used to encrypt the back-up file SD is present in the device at all. In the context of the invention, any password P which is stored in a non-volatile memory area within the pocket PC can, in principle, be used for this purpose. In this case, it may, for example, be a password which is used by the BIOS and is stored in a non-volatile memory (which usually cannot be removed) of the pocket PC. Alternatively, a password of the operating system could also be used, the password then frequently being stored, however, on a non-volatile but replaceable storage medium NF which is also used to store the back-up file SD. In this case, although it is possible to tie a user to the back-up file, it is not possible to tie a device to the back-up file. The password used is, in principle, irrelevant to the inventive method but a password to be used must be unambiguously defined when implementing the method. In the exemplary embodiment shown, this is intended to be the password associated with the access protection provided by the BIOS. This is frequently also referred to as the system password.

In operation B, it is not only possible to check whether the agreed password P is present but also to check whether its use is desired. If one of these two checks is negated, the method branches to operation D3. If, in contrast, the agreed password P is present and its use is desired, the method branches to operation C. The fact of whether or not use of an agreed password is desired may be set, for example, in a configuration file so that the task of checking this setting does not result in any interaction with the user. It is also conceivable for a field for optionally entering a key to be provided in a dialogue window while creating the back-up file SD. If the field is not filled in, the password P, if present, is used (branch to operation C), and if a key has been entered, the latter is used (branch to operation D3).

The system password P selected by way of example comprises a device-dependent part P_{GAT} and a device-independent part P_{GUT}. The device-dependent part P_{GAT} is hard-wired and clearly bears the hardware which is used in the device. The device-independent part P_{GUT} may be freely selected by the user. Only this part P_{GUT} needs to be input by the user in order to unlock access protection. The device-dependent part P_{GAT} is automatically and transparently added by the BIOS and thus prevents access to the device by means of possible hardware manipulation operations. In the case of checks which are not intended to be subject to this security restriction, the device-dependent part P_{GAT} of the system password P may also remain out of consideration. These two alternative possibilities are also possible in the exemplary embodiment of FIG. 1 for encrypting the back-up file SD. For this purpose, operation C checks a setting which is to be carried out by the user in order to determine whether or not encryption is intended to be specific to the device. If device-specific encryption is desired, the key S used for encryption is set to the entire password P in operation D2. If, in contrast, device-dependent encryption is not desired, only the device-independent part P_{GUT} of the system password is adopted as the key S in operation D1. As a third possibility, D3 finally makes it possible for the user to input a key S which is specific to this encryption operation, if the key was desired further above in operation B or if no password P is present.

This key S is then used in operation E to encrypt the back-up file SD. All known symmetrical methods, e.g., RSA, AES, Twofish, Blowfish etc., may be used for encryption. This is known from the prior art and will likewise not be explained any further detail here.

In operation F, encryption information IS is also added to the back-up file SD. This information IS makes it possible, during decryption, to determine whether or not a key is suitable. This may be achieved, for example, by adding a clear but irreversible representation of the key S, together with information regarding the key algorithm used, to the back-up file SD. The method finally ends after operation G after the back-up file SD has been stored on the non-volatile storage medium NF. In general, a solid-state memory card, for example a memory card using flash technology, is used as the non-volatile storage medium NF in pocket PCs.

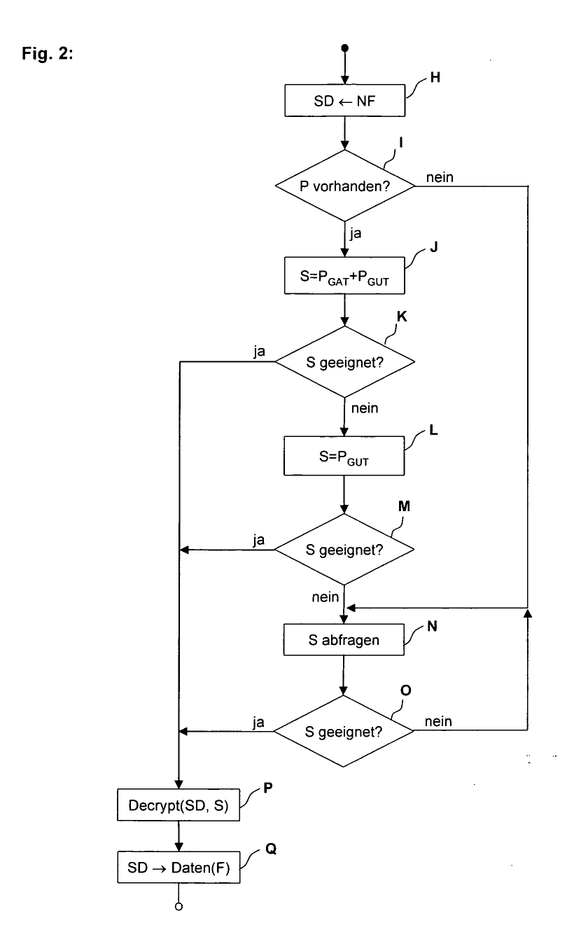

FIG. 2 shows the flowchart of a method for decrypting an encrypted back-up file in a pocket PC. This method is the complementary opposite to the method described in connection with FIG. 1 and accordingly begins in operation H with the operation of reading in the encrypted back-up file SD from the non-volatile storage medium NF.

In a manner similar to that in operation B from FIG. 1, subsequent operation I checks whether the agreed password P is present at all in the device used in this case. If not, the method branches to operation N which will be described later.

If the agreed password is present, the complete password P comprising its device-dependent part P_{GAT} and its device-independent part P_{GUT} is set as the key for decryption. In operation K, a test is carried out to determine whether the key S which has been set in this manner is suitable for decrypting the back-up file SD. This test becomes possible as a result of the encryption information IS which was added to the back-up file in operation F from FIG. 1.

If decryption using this key S is not possible, i.e., the key is not “suitable”; the key S is reduced to the device-independent part P_{GUT} of the password P in operation L. In a manner similar to that in operation K, operation N checks whether decryption using this key S is possible. If this is also negated, the user is expected to input a key S in operation N. This also takes place if operation I determined that there is either no agreed password P or the use thereof is not desired.

Operation 0 then also checks whether the key S which has been entered by the user is suitable for decrypting the back-up file. If not, the method branches to operation N again for another opportunity to specify the key S. In addition, it is possible to end the method without success which is not shown here for reasons of clarity.

If one of the checks in operation K, N or 0 has revealed that the present key S is suitable for decrypting the back-up file SD, the method branches to operation P in which this decryption is carried out using the key S in accordance with the decryption method specified in the encryption information IS. In operation Q, the decrypted information from the back-up file is then finally written back to the volatile memory F in a reversal of operation A from FIG. 1.

In the event of the back-up file SD having been created and its data having been restored on the same device, the inventive methods thus make it possible to encrypt and decrypt a back-up file without the user being required to input a key. The same also applies if, although the back-up file SD was restored on another device, no device-specific parts P_{GAT} of the password were used for encryption and both devices have the same device-independent part P_{GUT} of the password P. This makes it possible, for example, for data to be interchanged as desired between a plurality of devices belonging to the same user.

Having described preferred embodiments of the invention, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

### List of Reference Symbols

F: Volatile memory
NF: Non-volatile storage medium
SD: Back-up file
P: Password
P_{GAT}: Device-dependent part of the password P
P_{GUT}: Device-independent part of the password P
S: Key
IS: Encryption information

1. A method for encrypting a back-up file in a pocket PC, comprising:
determining a password in the pocket PC;
adopting the password as a key; and
encrypting a back-up file using the key.

2. The method of claim 1, wherein the password is the password associated with access protection for the pocket PC.

3. The method of claim 1, wherein the password is stored in the basic input output system (BIOS) of the pocket PC.

4. The method of claim 1, wherein the password is stored in the operating system of the pocket PC.

5. The method of claim 1, wherein the password comprises a device-dependent part and a device-independent part, and wherein only the device-independent part of the password is used for encryption.

6. A method for restoring data from an encrypted back-up file in a pocket PC, comprising:
determining a password in the pocket PC;
adopting the password as a key; and
decrypting a back-up file using the key.

7. The method of claim 6, further comprising:
determining whether the decryption of the back-up file using the key was successful;
requesting a user to enter a key;
reading in the key entered by the user; and
decrypting the back-up file using the key entered by the user.

8. The method of claim 6, wherein the password is associated with access protection for the pocket PC.

9. The method of claim 6, wherein the password is stored in the basic input output system (BIOS) of the pocket PC.

10. The method of claim 6, wherein the password is stored in the operating system of the pocket PC.

11. A pocket PC that is configured to create an encrypted back-up file, wherein the pocket PC is operable to determine a password in the pocket PC, adopt the password as a key, and encrypt the back-up file using the key.

12. The pocket PC of claim 11, further comprising a volatile memory from which data is backed up, and a non-volatile storage medium in which the encrypted back-up file is stored.

13. A pocket PC that is configured to restore data from an encrypted back-up file, wherein the pocket PC is operable to determine a password in the pocket PC, adopt the password as a key, and decrypt the back-up file using the key.

14. A computer readable medium storing instructions, that when executed by a pocket PC, cause the pocket PC to perform the functions of:
determining a password in the pocket PC;
adopting the password as a key; and
encrypting a back-up file using the key.

15. A computer readable medium storing instructions, that when executed by a pocket PC, cause the pocket PC to perform the functions of:
determining a password in the pocket PC;
adopting the password as a key; and
decrypting a back-up file using the key.
